(19) United States
(12) Patent Application Publication
(10) Pub. No.: US 2025/0145113 A1
(43) Pub. Date: May 8, 2025

(54) COMMUNICATION BETWEEN LANYARD AND INDUSTRIAL VEHICLE

(71) Applicant: Crown Equipment Corporation, New Bremen, OH (US)

(72) Inventors: Dean E. Winner, Celina, OH (US); Thomas Langenkamp, Coldwater, OH (US); Claire Spicer, Anna, OH (US)

(21) Appl. No.: 18/940,203

(22) Filed: Nov. 7, 2024

Related U.S. Application Data
(60) Provisional application No. 63/596,856, filed on Nov. 7, 2023.

(51) Int. Cl. B60R 25/22; B60R 25/24

(52) U.S. Cl. CPC B60R 25/22; B60R 25/241

(57) ABSTRACT

A process for enabling an industrial vehicle comprises an industrial vehicle determining whether the industrial vehicle includes a lanyard that is associated to the industrial vehicle. The industrial vehicle receives login credentials from an operator. If the lanyard transitions from an unsecured state to a secured state, then the industrial vehicle is enabled.

### CROSS REFERENCE TO RELATED APPLICATIONS

This application claims the benefit of U.S. Provisional Patent Application Ser. No. 63/596,856, filed Nov. 7, 2023, entitled “COMMUNICATION BETWEEN LANYARD AND INDUSTRIAL VEHICLE”, the disclosure of which is hereby incorporated by reference.

### BACKGROUND

The present disclosure relates to electronic systems that collect information related to the operation of industrial vehicles in industrial applications, and in particular to the utilization of lanyards and harnesses in industrial vehicles.

### BRIEF SUMMARY

According to aspects of the present disclosure, a process for enabling an industrial vehicle comprises an industrial vehicle determining whether the industrial vehicle includes a lanyard that is associated to the industrial vehicle. The industrial vehicle receives login credentials from an operator. If the lanyard transitions from an unsecured state to a secured state, then the industrial vehicle is enabled.

Optionally, determining whether the industrial vehicle includes a lanyard that is associated to the industrial vehicle comprises receiving a wireless status message from the lanyard, wherein the wireless status message includes identification data of the lanyard.

Determining, if the industrial vehicle includes the lanyard, that the lanyard is secured after the lanyard was not secured may comprise detecting an edge on a signal from the lanyard, wherein the signal indicates a secured state of the lanyard.

Further optionally determining, if the industrial vehicle includes the lanyard, that the lanyard is secured after the lanyard was not secured comprises receiving a status message indicating that the lanyard is in an unsecured state and then receiving a status message indicating that the lanyard is in a secured state.

Determining that the lanyard is secured after the lanyard was not secured may occur after receiving the login credentials from the operator or within a predetermined time period before receiving the login credentials from the operator.

The process may further comprise keeping the industrial vehicle enabled until the operator logs out or unsecures the lanyard.

According to further aspects of the present disclosure, a process for associating a lanyard having wireless communication with an industrial vehicle comprises receiving, on an industrial vehicle, a request from a lanyard to wirelessly pair with the industrial vehicle, wherein the request includes identification information of the lanyard. The industrial vehicle sends an instruction to an operator to perform a task of unsecuring the lanyard and securing the lanyard, and the task needs to be performed a predetermined number of times. The industrial vehicle wirelessly receives an indication that the lanyard is secured after the lanyard was not secured for the predetermined number of times and the indication includes the identification information of the lanyard. The lanyard is associated with the industrial vehicle for communication after determining that the lanyard has been secured after the lanyard was not secured for the predetermined number of times.

Optionally, the process further comprises sending the identification information of the lanyard to a screen for display to the operator and optionally filtering out any identification information that is not associated with a lanyard.

The process for associating the lanyard with the industrial vehicle may include receiving, from the operator, an indication whether the identification information of the lanyard is correct.

Sending an instruction to an operator to perform a task, for a predetermined number of times, of unsecuring the lanyard and securing the lanyard may include sending an instruction to a screen for the operator to perform the task.

Receiving an indication that the lanyard is secured after the lanyard was not secured for the predetermined number of times further may comprise receiving periodic status message from the lanyard that indicates whether the lanyard is secured or unsecured.

Optionally, sending an instruction to an operator to perform a task, for a predetermined number of times, of unsecuring the lanyard and securing the lanyard comprises counting a number of times the operator has performed the task; and updating the instruction for the operator to perform the task for the predetermined number of times minus the number of times that the operator has performed the task.

According to further aspects of the present disclosure, a process for enabling an industrial vehicle (or certain controls of the vehicle) includes both the processes described above.

### BRIEF DESCRIPTION OF THE SEVERAL VIEWS OF THE DRAWINGS

FIG. 1 is a block diagram of a system for operating industrial vehicles, according to aspects of the disclosure;

FIG. 2 is a block diagram of a system of electronics on an industrial vehicle such as a forklift truck, which includes an information linking device, an environmental-based location tracking device, and a secondary wireless communicator, according to aspects of the present disclosure;

FIG. 3 is a diagram illustrating a lanyard and harness of an industrial vehicle, according to aspects of the present disclosure;

FIG. 4 is a flow chart illustrating a process for enabling an industrial vehicle based on a lanyard status, according to aspects of the present disclosure;

FIG. 5 is a flow chart illustrating a process for associating a lanyard with an industrial vehicle, according to aspects of the present disclosure;

FIG. 6 is an example of a screen showing an instruction to perform a task in association with the process of FIG. 5, according to aspects of the present disclosure; and

FIG. 7 is a block diagram of a computer processing system capable of implementing any of the systems or processes (or subsets thereof) described more fully herein.

### DETAILED DESCRIPTION

Many industrial vehicles include a safety harness and a lanyard that couples the harness to the industrial vehicle. However, not all industrial vehicle manufacturers require that the lanyard be manufactured by the vehicle manufacturer, so some industrial vehicles include third-party lanyards. In many instances, the lanyard acts not only as a safety coupling between the operator and the industrial vehicle, but it also wirelessly sends information to the industrial vehicle to make sure it is secured before the industrial vehicle can be fully enabled.

In some instances, an operator may wish to circumvent the precautions of the lanyard. In other words, the operator may try to operate the vehicle without coupling the lanyard to the safety harness. To do so, some operators just keep the lanyard secured to a metal structure on the vehicle at all times over numerous operator logins. The lanyard erroneously determines that the lanyard is secured properly and allows the vehicle to be enabled.

Embodiments of a process disclosed herein prevent such an action by the operator by looking for a transition of the lanyard from an unsecured state to a secured state, instead of just looking for the lanyard to be in the secured state at operator login. Thus, the process should help prevent such operator circumvention.

Further, another process is disclosed to help the industrial vehicle determine which lanyard wants to pair with the vehicle amongst many other lanyards trying to pair with many other industrial vehicles. The process has an operator perform a task of unsecuring and securing the lanyard for a predetermined number of times, which helps the operator and the vehicle determine which identification information is associated with the lanyard that wants to pair with the vehicle amongst many other lanyards trying to pair with many other industrial vehicles.

### System Overview

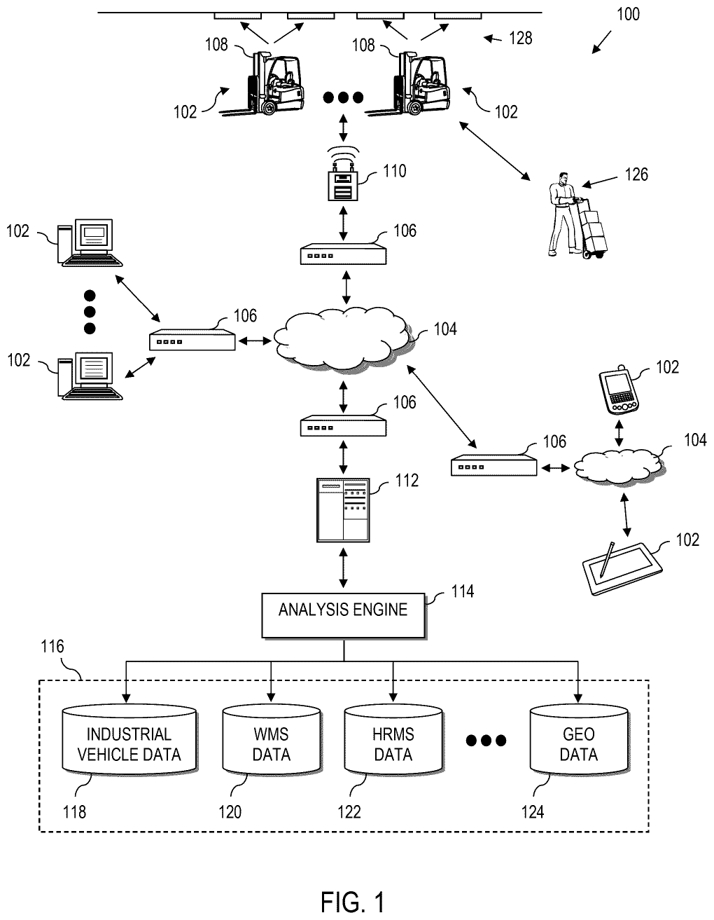

Referring now to the drawings and in particular to FIG. 1, a general diagram of a system 100 is illustrated according to various aspects of the present disclosure. The illustrated system 100 is a special purpose (particular) computing environment that includes a plurality of hardware processing devices (designated generally by the reference 102) that are linked together by one or more network(s) (designated generally by the reference 104).

The network(s) 104 provides communications links between the various processing devices 102 and may be supported by networking components 106 that interconnect the processing devices 102, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 104 may comprise connections using one or more intranets, extranets, local area networks (LAN), wide area networks (WAN), wireless networks (Wi-Fi), the Internet, including the world wide web, cellular and/or other arrangements for enabling communication between the processing devices 102, in either real time or otherwise (e.g., via time shifting, batch processing, etc.).

A processing device 102 can be implemented as a server, personal computer, laptop computer, netbook computer, purpose-driven appliance, special purpose computing device and/or other device capable of communicating over the network 104. Other types of processing devices 102 include for example, personal data assistant (PDA) processors, palm computers, cellular devices including cellular mobile telephones and smart telephones, tablet computers, an electronic control unit (ECU), a display of the industrial vehicle, etc.

Still further, a processing device 102 is provided on one or more industrial vehicles 108 such as a forklift truck, reach truck, stock picker, automated guided vehicle, turret truck, tow tractor, rider pallet truck, walkie stacker truck, etc. In the example configuration illustrated, the industrial vehicles 108 wirelessly communicate through one or more access points 110 to a corresponding networking component 106, which serves as a connection to the network 104. Alternatively, the industrial vehicles 108 can be equipped with Wi-Fi, cellular or other suitable technology that allows the processing device 102 on the industrial vehicle 108 to communicate directly with a remote device (e.g., over the networks 104).

The illustrative system 100 also includes a processing device implemented as a server 112 (e.g., a web server, file server, and/or other processing device) that supports an analysis engine 114 and corresponding data sources (collectively identified as data sources 116). The analysis engine 114 and data sources 116 provide domain-level resources to the industrial vehicles 108. Moreover, the data sources 116 store data related to activities of the industrial vehicles 108, including captured events, industrial vehicle encounters with electronic devices (e.g., an electronically enabled lanyard that couples to a harness) and geo-features, combinations thereof, etc., as described in greater detail herein.

In an exemplary implementation, the data sources 116 include a collection of databases that store various types of information related to an operation (e.g., a warehouse, distribution center, retail store, manufacturer, etc.). However, these data sources 116 need not be co-located. In the illustrative example, the data sources 116 include databases that tie processes executing for the benefit of the enterprise, from multiple, different domains. In the illustrated example, data sources 116 include an industrial vehicle information database 118 (supporting processes executing in an industrial vehicle operation domain), a warehouse management system (WMS) 120 (supporting processes executing in WMS domain that relate to movement and tracking of goods within the operating environment), a human resources management system (HRMS) 122 (supporting processes executing in an HRMS domain), a geo-feature management system 124 (supporting processes that utilize environmental-based location tracking data of industrial vehicles in a geo-domain), etc. The above list is not exhaustive and is intended to be illustrative only.

Still further, the industrial vehicles 108 include a short range, direct communication with electronic devices 126 that can be remote, but in relatively close proximity (by way of example, 15-20 meters) to a corresponding industrial vehicle 108. Electronic devices 126 can also be positioned on machines, fixtures, equipment, other objects, an industrial vehicle operator, combinations thereof, etc., as will be described in greater detail herein.

One or more of the industrial vehicles 108 can also include an optional environmental-based location tracking device that works with a location tracking system schematically represented by 128, which allows position determination of the industrial vehicle 108, even when operating indoors where a traditional global positioning system (GPS) is ineffective. As will be described in greater detail herein, environmental-based location tracking can be utilized to effectively map and track the location of an industrial vehicle 108 in a dimensionally constrained environment, e.g., a mapped indoor portion of a warehouse.

### Industrial Vehicle

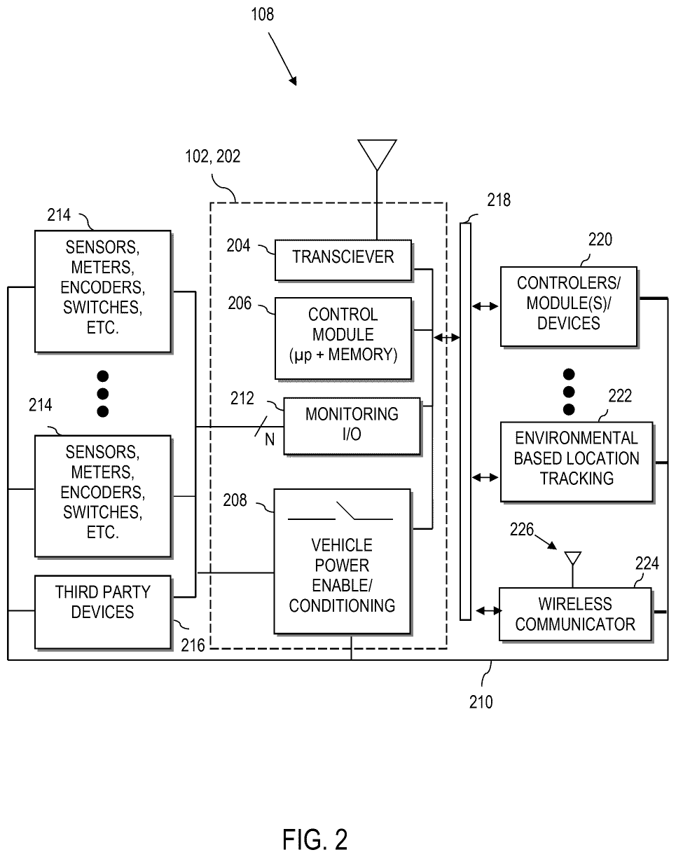

Referring to FIG. 2, one or more industrial vehicles 108 include a processing device 102 that is implemented as a special purpose, particular computer, (further designated herein as an information linking device 202) that mounts to or is otherwise integrated with the industrial vehicle 108 (FIG. 1).

The information linking device 202 comprises the necessary circuitry to implement wireless communication, data and information processing, and wired (and optionally wireless) communication to components of the industrial vehicle 108. As a few illustrative examples, the information linking device 202 includes a transceiver 204 for wireless communication. Although a single transceiver 204 is illustrated for convenience, in practice, one or more wireless communication technologies may be provided. For instance, the transceiver 204 communicates with a remote server, e.g., server 112 of FIG. 1, via 802.11.xx across the access points 110 of FIG. 1. The transceiver 204 may also optionally support other wireless communication, such as cellular, Bluetooth, infrared (IR) or any other technology or combination of technologies. For instance, using a cellular to IP bridge the transceiver 204 can use a cellular signal to communicate directly with a remote server, e.g., a manufacturer server across a network 104 (FIG. 1).

The information linking device 202 also comprises a control module 206, having a processor coupled to memory for implementing computer instructions, including computer-implemented processes, or aspects thereof, as set out and described more fully herein. The control module 206 communicates with the components set forth in FIG. 2 described more fully herein making the information linking device 202 a particular machine different from a general-purpose computer. For instance, the control module 206 utilizes the transceiver 204 to exchange information with a remote server 112 (FIG. 1) for controlling operation of the industrial vehicle 108, for remotely storing information extracted from the industrial vehicle 108, etc.

The information linking device 202 further includes power enabling circuitry 208 controlled by the control module 206 to selectively enable or disable the industrial vehicle 108 (or alternatively, to selectively enable or disable specific control modules or vehicle functions such as hydraulic, traction, etc.). For instance, the control module 206 can control the industrial vehicle power enabling circuitry 208 to provide power to the industrial vehicle 108, select components of the industrial vehicle 108, select vehicle functions, etc. via power line 210, e.g., based upon operator login, detected geo-features, etc

Still further, the information linking device 202 includes a monitoring input output (I/O) module 212 to communicate via wired or wireless connection to peripheral devices attached to or otherwise mounted on the industrial vehicle 108, such as sensors, meters, encoders, switches, etc. (collectively represented by reference numeral 214). The module 212 may also be connected to other devices, e.g., third party devices 216 such as RFID scanners, displays, meters or other devices. This allows the control module 206 to obtain and process information monitored on the industrial vehicle 108.

The information linking device 202 is coupled to and/or communicates with other industrial vehicle system components via a suitable vehicle network bus 218. The vehicle network bus 218 is any wired or wireless network, bus or other communications capability that allows electronic components of the industrial vehicle 108 to communicate with each other. As an example, the vehicle network bus 218 may comprise a controller area network (CAN) bus, Local Interconnect Network (LIN), time-triggered data-bus protocol (TTP) or other suitable communication technology.

As will be described more fully herein, utilization of the vehicle network bus 218 enables seamless integration of the control module 206 and other components of the information linking device 202 into native electronics of the industrial vehicle 108. In the example configuration, the control module 206 of the information linking device 202 connects with, understands and is capable of communication with native vehicle electronic components, such as traction controllers, hydraulic controllers, modules, devices, bus enabled sensors, displays, lights, light bars, sound generating devices, headsets, microphones, haptic devices, etc. (collectively referred to by reference 220).

### Environmental-Based Location Tracking

According to yet further aspects of the present disclosure, an environmental-based location tracking device 222 is provided on the industrial vehicle 108. As illustrated, the environmental-based location tracking device 222 is connected to the vehicle electronics via the vehicle network bus 218 (e.g., CAN bus). As a result, the environmental-based location tracking device 222 can communicate directly with the control module 206, as well as other devices linked to the vehicle network bus 218 of the corresponding industrial vehicle 108. The environmental-based location tracking device 222 enables the industrial vehicle 108 to be spatially aware of its location within a dimensionally constrained environment, e.g., a mapped portion of a warehouse.

In the applications described more fully herein, a conventional technology such as a global positioning system (GPS) is not likely to be effective when the industrial vehicle 108 is operated indoors. However, the environmental-based location tracking device 222 can comprise a local awareness system that utilizes markers, including fiducial markers, RFID, beacons, lights, or other external devices to allow spatial awareness within the warehouse environment. Moreover, local awareness can be implemented by machine vision guidance systems, e.g., using one or more cameras. The environmental-based location tracking device 222 may also/alternatively use transponders and triangulation calculations to determine position. Yet further, the environmental-based location tracking device 222 can use combinations of the above and/or other technologies to determine the current (real-time) position of the industrial vehicle 108. As such, the position of the industrial vehicle 108 can be continuously ascertained (e.g., every second or less) in certain implementations. Alternatively, other sampling intervals can be derived to continuously (e.g., at discrete defined time intervals, periodic or otherwise constant and recurring time intervals, intervals based upon interrupts, triggers or other measures) determine industrial vehicle position over time.

The environmental-based location tracking device 222 can also use knowledge read from inertial sensors, vehicle sensors, encoders, accelerometers, gyroscopes, etc., (e.g., via the controllers 220 across the vehicle network bus 218, via sensors 214 and/or third party devices 216 across the monitoring I/O 212 and vehicle network bus 218, etc.) to determine the position of the industrial vehicle 108 within the warehouse and/or to augment or modify the position determination from the location tracking device 222.

The environmental-based location tracking device 222 is aware of the absolute position of the industrial vehicle 108 within a dimensionally limited environment, e.g., a mapped portion of a warehouse. By “absolute” position, it is meant that the vehicle position is known relative to a map. The map may be a regional area, e.g., only a portion of an indoor facility such as a warehouse. Absolute position is to be differentiated from relative or offset position. A relative offset position can be a general description of an offset distance, e.g., 2 meters away, without also knowing the direction of the offset.

Alternatively, the relative offset position can be a general description of a direction without a distance, e.g., towards the power unit of the industrial vehicle 108, without knowing the precise distance. In other examples, the relative offset position can be a precise measure of both offset and direction, 2 meters away in direction X, Y, Z. In this situation, orientation or a standardized reference plane should be established to ensure that offset position is accurately translated to absolute position, and vice-versa. In certain illustrative implementations, the absolute position of the industrial vehicle may be known, but orientation may be unknown. In other implementations, orientation and absolute position are known.

### Secondary Wireless Communicator

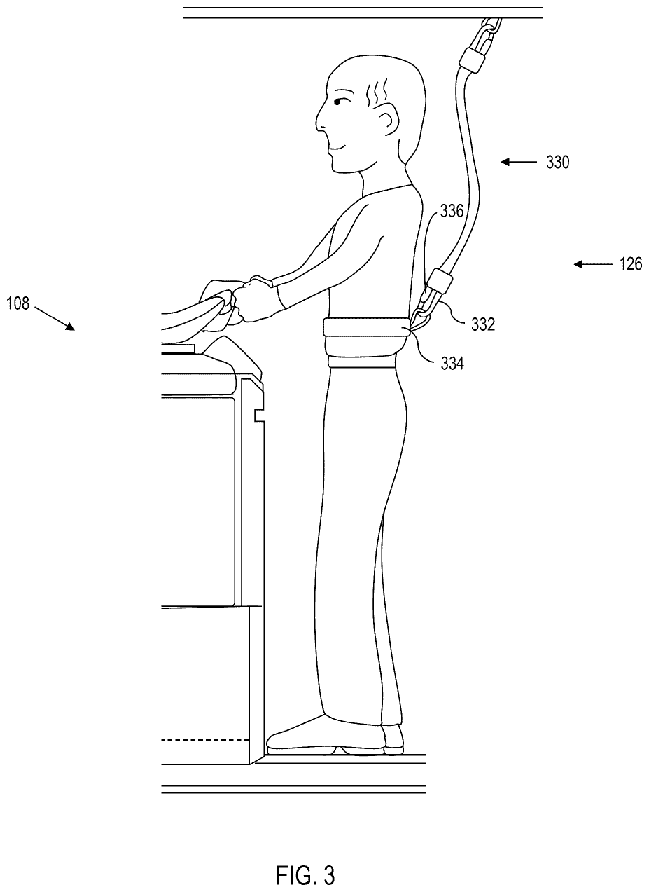

The information linking device 202 also communicates with a secondary wireless communicator 224. The secondary wireless communicator 224 includes a transceiver for short range communication with suitably configured electronic devices (e.g., electronic device 126 of FIG. 1, lanyard 330 of FIG. 3) in the vicinity of the secondary wireless communicator 224, e.g., by way of non-limiting example, in the range of about 15-20 meters or less. The secondary wireless communicator 224 can communicate using any proprietary or standardized communication protocol including Bluetooth (over IEEE 802.15.1), ultra-wideband (UWB, over IEEE 802.15.3), ZigBee (over IEEE 802.15.4), Wi-Fi (over IEEE 802.11), WiMax (over IEEE 802.16), etc.

In certain illustrative implementations, the secondary wireless communicator 224 includes an antenna 226.

As illustrated, the secondary wireless communicator 224 is connected to the vehicle electronics via the vehicle network bus 218 (e.g., CAN bus). As a result, the secondary wireless communicator 224 can communicate directly with the control module 206, as well as controllers and other modules 220 of the corresponding industrial vehicle 108. Thus, the secondary wireless communicator 224 can pass information related to the detection of proximate electronic devices 126 to the control module 206 of the information linking device 202. The control module 206 of the information linking device 202 can then process the received information related to the detection of proximate electronic devices 126, send commands to vehicle controllers and modules 220, take action based upon a known location of the industrial vehicle 108 via information collected from the environmental-based location tracking device 222, pass information back to the secondary wireless communicator 224, communicate the collected information to a remote server (e.g., server 112 of FIG. 1), take action based upon information received from the remote server, combinations of thereof, etc.

### Lanyard and Harness

Turning now to FIG. 3, an electronic device 126 in the form of a lanyard 330 (i.e., a tether) that is coupled to an industrial vehicle (e.g., an industrial vehicle 108, FIG. 1). Any way of securing the lanyard 330 to the industrial vehicle 108 may be used. The lanyard 330 includes a coupler 332 that allows the lanyard 330 to be coupled to a safety harness 334 (also including a safety belt, as shown in FIG. 3). The coupler 332 includes a latch 336 (also called a gate) that when closed and metal (e.g., metal of the ring of the harness) is detected in the coupler 332, the lanyard 330 is in a secured state (i.e., has a secured status). However, when the latch 336 (i.e., gate) is open, then the lanyard is in an unsecured state (i.e., has an unsecured status). The latch 336 may be closed in any conventional way (e.g., biased with a spring, include a collar that screws into place); for example, the coupler 332 and latch 336 may be a carabiner.

The lanyard further includes electronics (not shown) that wirelessly transmit identification information and status information of the lanyard 330 to the industrial vehicle 108 using the secondary wireless communicator (224, FIG. 2) on the industrial vehicle. For example, the identification information includes a unique number associated with the lanyard to aid in wirelessly pairing the lanyard 330 to the industrial vehicle 108. As another example, the status information includes whether the lanyard 330 is in a secured state or unsecured state. Further, the electronics in the lanyard 330 can sense whether the latch 336 is opened or closed, which allows the electronics to know the state of the lanyard 330.

### Anti-Bypass Measures

As discussed above, some industrial vehicles 108 include a lanyard 330 that allows an operator to be secured in the vehicle. In many embodiments, the lanyard 330 includes electronics to determine the status of the lanyard 330 and communicate that status to the industrial vehicle 108. The industrial vehicle 108 may then use that status information to determine whether the vehicle should be fully enabled. For example, if the lanyard is in an unsecured state, then the industrial vehicle may be placed in a “limp” mode where many of the options of the vehicle are not activated and the vehicle has a very slow maximum speed limit. However, if the lanyard is in a secured state then the industrial vehicle may be fully enabled.

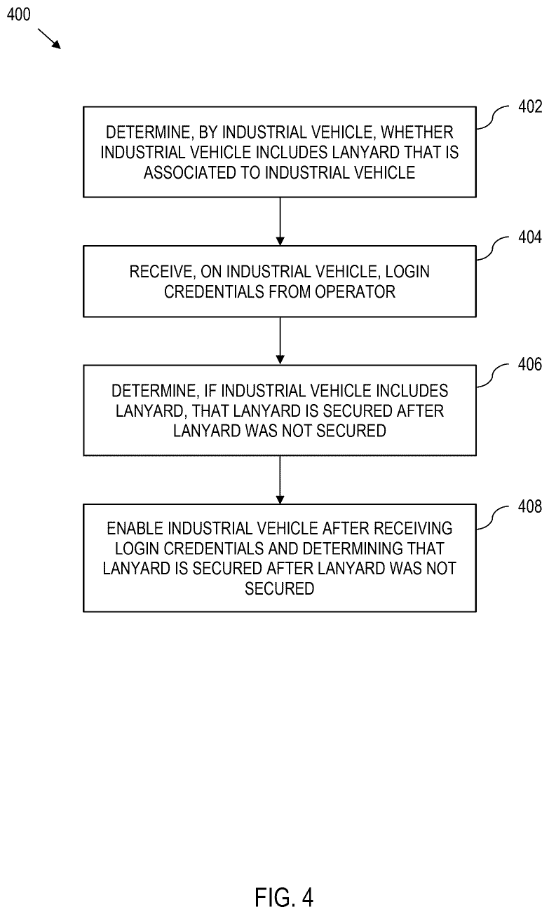

Turning now to FIG. 4, a process 400 for enabling an industrial vehicle is shown. At 402, the industrial vehicle determines whether the industrial vehicle includes a lanyard that is associated with the industrial vehicle. As discussed above, there are several processors on the industrial vehicle who can communicate with the secondary wireless communicator (224 FIG. 2) via the vehicle network bus. Thus, information received by the secondary wireless communicator is transmitted on the vehicle network bus to the processor(s) of the industrial vehicle.

For example, if the industrial vehicle is wirelessly paired (e.g., via Bluetooth) with a lanyard (as discussed below), then the vehicle includes a lanyard that is associated with the industrial vehicle. In many embodiments, the industrial vehicle receives identification information from the lanyard, as discussed in greater detail below. If the industrial vehicle does not include a lanyard, then the process will end.

At 404, login credentials are received by the industrial vehicle. For example, an operator that would like to use the industrial vehicle enters a name and password, uses a fob with credentials, uses an identification badge that includes credentials, etc.

At 406, if the industrial vehicle includes a lanyard, then the industrial vehicle determines whether the lanyard has transitioned from an unsecured state to a secured state. For example, the lanyard periodically sends status information to the industrial vehicle, and the industrial vehicle looks for the lanyard being secured after the lanyard has been unsecured. In other embodiments, the industrial vehicle looks for an edge on a signal that indicates the status of the lanyard to determine if the lanyard is secured after the lanyard was not secured.

At 408, the industrial vehicle is fully enabled if the industrial vehicle detected the transition of the lanyard from the unsecured state to the secured state. To enable the vehicle, a processor of the vehicle sends commands, set points, parameters, etc. to the various control modules of the industrial vehicle via the vehicle network bus, as discussed above. The industrial vehicle may remain fully enabled until either the operator logs out or the operator unsecures the lanyard.

As used herein enabling the vehicle includes a check to see the transition of the lanyard from the unsecure state to the secure state, but other checks may be made as well. For example, if the battery of the lanyard is below a threshold, then even if the transition of the lanyard from the unsecure state to the secure state is detected, then the industrial vehicle may not be enabled.

While the process 400 illustrates that the login credentials are received before determination of whether the lanyard status changed from unsecured to secured, such timing is not required. For example, in various embodiments, if an operator secures an unsecured lanyard and then within a predetermined period of time enters login credentials, then such a sequence will result in the industrial vehicle being enabled. Thus, the window for the transition of the lanyard from an unsecured state to a secured state may span before receiving the login credentials by a predetermined time period (e.g., thirty seconds, sixty seconds, etc.) to an amount of time after receiving the login credentials.

Embodiments of the process 400 for enabling the industrial vehicle described herein prevent an operator from securing the lanyard and keeping the lanyard secured for several logins. For example, some operators may try to circumvent conventional lanyard precautions by always keeping the lanyard secured over several logins to the industrial vehicle. Thus, if the industrial vehicle only looks at the current state of the lanyard to enable the vehicle (instead of looking for a transition from an unsecured state to the secured state), then such an action by the operator will circumvent the precautions. With embodiments of the process 400 herein, the industrial vehicle will not be enabled if the lanyard is in the secured state for more than one operator login. Thus, the operator will unsecure the lanyard, couple the lanyard to the operator's safety harness, and secure the lanyard for each time the operator logs into the industrial vehicle. Therefore, the process 400 described herein helps prevent operators from circumventing the lanyard precautions when requesting to enable the industrial vehicle.

### Associating the Lanyard to the Industrial Vehicle

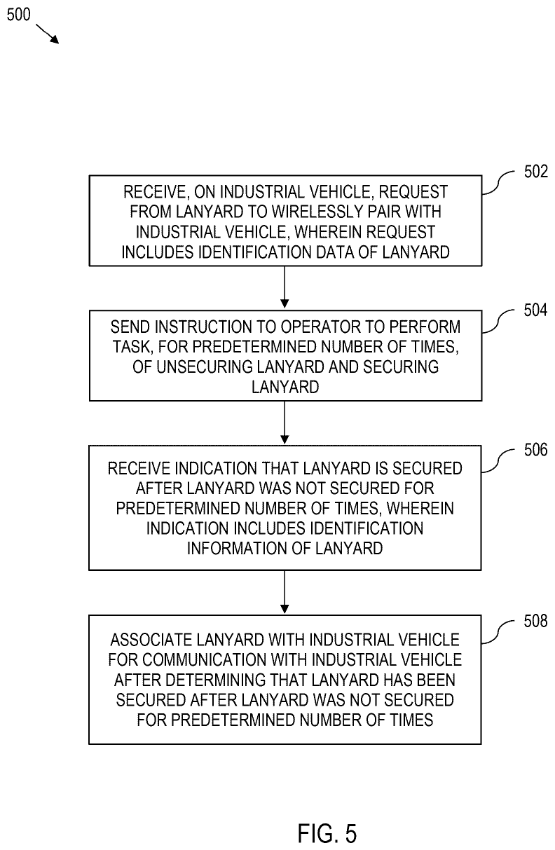

Turning now to FIG. 5, a process 500 for associating a lanyard with an industrial vehicle is shown. For example, in a system with an industrial vehicle and a lanyard that communicate via Bluetooth, the lanyard and the industrial vehicle need to be paired. However, in an industrial environment, many Bluetooth devices may be communicating and trying to pair at the same time. Therefore, embodiments of the process 500 for associating a lanyard with an industrial vehicle helps pair the correct lanyard with the correct industrial vehicle.

At 502, the industrial vehicle receives a request from a lanyard to pair with the industrial vehicle. The lanyard supplies identification information to the industrial vehicle. For example, the lanyard supplies its identification serial number to the industrial vehicle.

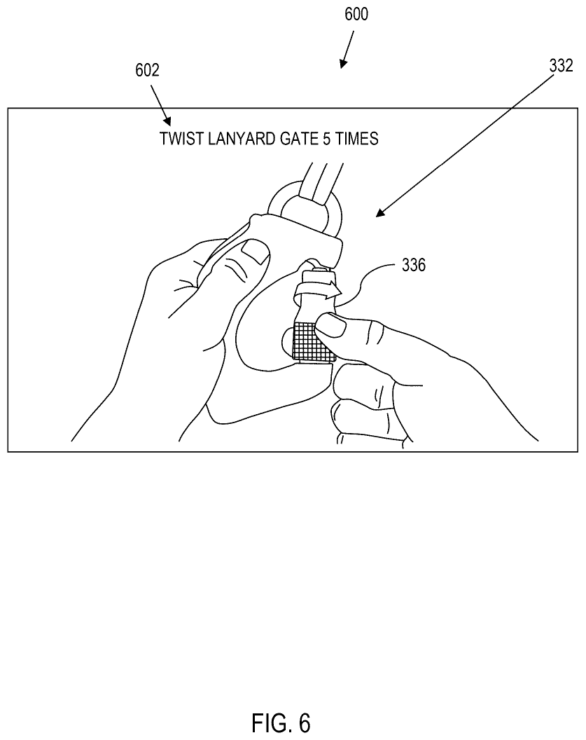

At 504, the industrial vehicle sends an instruction to an operator to perform a task of unsecuring the lanyard and securing the lanyard, where the task should be performed for a predetermined number of times. For example and turning briefly to FIG. 6, the industrial vehicle may display on a screen 600 an instruction 602 to the operator to twist the gate 336 (i.e., latch) of the coupler 332 of the lanyard five times to unsecure and secure the lanyard five times.

Turning back to FIG. 5, at 506, an indication that the lanyard is secured after the lanyard was not secured for the predetermined number of times is received-including identification information associated with the lanyard. For example as discussed above, the lanyard periodically sends status information to the industrial vehicle (e.g., wirelessly via the secondary wireless communicator (224 FIG. 2)). When the industrial vehicle detects that the lanyard has transitioned from unsecured to secured, the industrial vehicle can increment a counter. When the counter equals the predetermined number of times, then the vehicle knows that the operator has performed the task for the predetermined number of times.

In some embodiments, the industrial vehicle will update the display to the operator to let the operator know how many more times the operator must perform the task. Using FIG. 6 as an example, after the operator performs the task one time, the instruction 602 may be updated to state: “Twist lanyard gate 4 more times”. After the operator performs the task three times in total, the instruction 602 may be updated to state: “Twist lanyard gate 2 more times”. While the operator is performing the task, the operator can verify that the actions that they are performing are affecting the number of times remaining to perform the task on the screen.

Turning back to FIG. 5, at 508, the industrial vehicle associates the lanyard with the industrial vehicle after determining that the operator has performed the task for the predetermined number of times. In many embodiments, after the industrial vehicle determines that the operator has performed the task for the predetermined number of times, the industrial vehicle will display the identification information of the lanyard that had the task performed upon it and filtering out any identification information not associated with the specific lanyard, so the operator will not select a different lanyard for pairing. The operator can then select the lanyard is correct for pairing.

By having an operator perform a task using the lanyard, the industrial vehicle can narrow down a list of lanyards trying to pair with a vehicle to the specific lanyard trying to pair with the specific industrial vehicle.

### Other Lanyard Messaging

As the industrial vehicle includes an information linking device (202, FIG. 2) and a display (600, FIG. 6), warning messages may be displayed on the screen. For example, the industrial vehicle can detect when the lanyard is disconnected from an operator (as discussed above) and detect a height of lift portions of the vehicle. Thus, if the industrial vehicle detects that the operator disconnects the lanyard above a predetermined height, then a message may be given to the operator to reconnect the lanyard. Further, the incidents of disconnects above the threshold may be stored with a timestamp and then transmitted to a remote server (e.g., 112, FIG. 1) via the information linking device (202, FIG. 2).

Moreover, the industrial vehicle may monitor a battery in the lanyard. Thus, the industrial vehicle may provide messages on the display relating to the battery state of the lanyard battery. For example, different thresholds of battery charge may be set, and a message provided on the display when the battery is between thresholds. For example, two thresholds can be 20% charge remaining and 5% charge remaining. When the battery is between 100% and the first threshold (20% remaining), then a first type of message is displayed or no message about battery charge is displayed (e.g., a small icon in a corner, nothing at all, etc.). When the battery charge surpasses the first threshold and is between the first threshold and the second threshold (e.g., 20-5% charge remaining), then a first message may be displayed indicating that the battery is running low and should be replaced soon. The operator may dismiss this message, and in some embodiments, a smaller reminder to replace the lanyard battery soon may still be displayed (e.g., a small message at a bottom of the display), but the reminder is not necessary. When the battery charge surpasses the second threshold (e.g., between 5-0%), then a second message may be displayed indicating that the battery is critically low (or out) of charge. The operator may dismiss this message, and in some embodiments, a smaller reminder to replace the lanyard battery now may still be displayed (e.g., a small message at a bottom of the display).

The thresholds above are for example purposes; any threshold can be used. For example, the second threshold may be 0% such that the second message is not displayed until the battery on the lanyard is totally out of charge.

### Computer System Overview

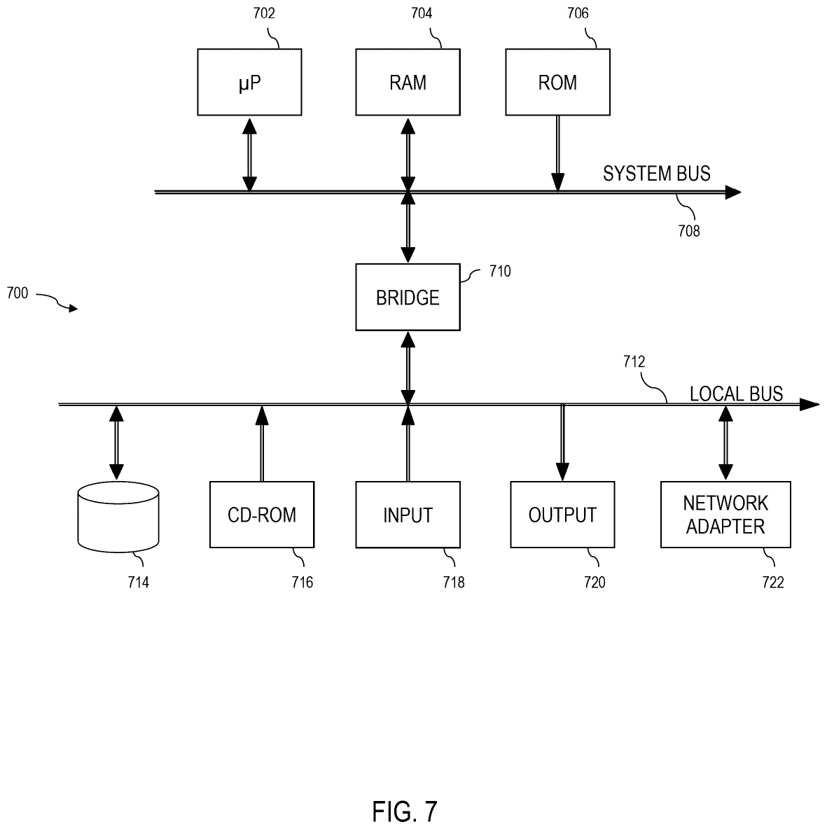

Referring to FIG. 7, a schematic block diagram illustrates an exemplary computer system 700 for implementing the various processes described herein. The exemplary computer system 700 includes one or more (hardware) microprocessors (μP) 702 and corresponding (hardware) memory (e.g., random access memory 704 and/or read only memory 706) that are connected to a system bus 708. Information can be passed between the system bus 708 and bus 812 by a suitable bridge 710 to communicate with various input/output devices. For instance, a local bus 712 is used to interface peripherals with the one or more microprocessors (μP) 702, such as storage 714 (e.g., hard disk drives); removable media storage devices 716 (e.g., flash drives, DVD-ROM drives, CD-ROM drives, floppy drives, etc.); I/O devices such as input device 718 (e.g., mouse, keyboard, scanner, etc.) output devices 720 (e.g., monitor, printer, etc.); and a network adapter 722. The above list of peripherals is presented by way of illustration, and is not intended to be limiting. Other peripheral devices may be suitably integrated into the computer system 700.

The microprocessor(s) 702 control operation of the exemplary computer system 700. Moreover, one or more of the microprocessor(s) 702 execute computer readable code (e.g., stored in the memory 704, 706 storage 714, removable media insertable into the removable media storage 716 or combinations thereof-collectively or individually, computer-program products) that instructs the microprocessor(s) 702 to implement the computer-implemented processes herein.

The computer-implemented processes herein may be implemented as a machine-executable process executed on a computer system, e.g., one or more of the processing devices 102 of FIG. 1, on a particular computing device such as the vehicle computer described with reference to FIG. 2, or combination thereof.

Thus, the exemplary computer system or components thereof can implement processes and/or computer-implemented processes stored on one or more computer-readable storage devices as set out in greater detail herein. Other computer configurations may also implement the processes and/or computer-implemented processes stored on one or more computer-readable storage devices as set out in greater detail herein. Computer-program code for carrying out operations for aspects of the present disclosure may be written in any combination of one or more programming languages. The program code may execute entirely on the computer system 700 or partly on the computer system 700. In the latter scenario, the remote computer may be connected to the computer system 700 through any type of network connection, e.g., using the network adapter 722 of the computer system 700.

In implementing computer aspects of the present disclosure, any combination of computer-readable medium may be utilized. The computer-readable medium may be a computer readable signal medium, a computer-readable storage medium, or a combination thereof. Moreover, a computer-readable storage medium may be implemented in practice as one or more distinct mediums.

A computer-readable signal medium is a transitory propagating signal per se. A computer-readable signal medium may include computer readable program code embodied therein, for example, as a propagated data signal in baseband or as part of a carrier wave. More specifically, a computer-readable signal medium does not encompass a computer-readable storage medium.

A computer-readable storage medium is a tangible device/hardware that can retain and store a program (instructions) for use by or in connection with an instruction execution system, apparatus, or device, e.g., a computer or other processing device set out more fully herein. Notably, a computer-readable storage medium does not encompass a computer-readable signal medium. Thus, a computer readable storage medium, as used herein, is not to be construed as being transitory signals per se, such as radio waves or other freely propagating electromagnetic waves through a transmission media.

Specific examples (a non-exhaustive list) of the computer-readable storage medium include the following: a hard disk, a random-access memory (RAM), a read-only memory (ROM), an erasable programmable read-only memory (EPROM), Flash memory, a portable computer storage device, an optical storage device such as a compact disc read-only memory (CD-ROM) or digital video disk (DVD), or any suitable combination of the foregoing. In particular, a computer-readable storage medium includes computer-readable hardware such as a computer-readable storage device, e.g., memory. Here, a computer-readable storage device and computer-readable hardware are physical, tangible implementations that are non-transitory.

By non-transitory, it is meant that, unlike a transitory propagating signal per se, which will naturally cease to exist, the contents of the computer-readable storage device or computer-readable hardware that define the claimed subject matter persists until acted upon by an external action. For instance, program code loaded into random access memory (RAM) is deemed non-transitory in that the content will persist until acted upon, e.g., by removing power, by overwriting, deleting, modifying, etc.

Moreover, since hardware comprises physical element(s) or component(s) of a corresponding computer system, hardware does not encompass software, per se.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the form disclosed. Many modifications and variations will be apparent to those of ordinary skill in the art without departing from the scope and spirit of the disclosure.

Having thus described the present application in detail and by reference to embodiments thereof, it will be apparent that modifications and variations are possible without departing from the scope defined in the appended claims.

What is claimed is:

1. A process for enabling an industrial vehicle, the process comprising:
determining, by an industrial vehicle, whether the industrial vehicle includes a lanyard that is associated to the industrial vehicle;
receiving, on the industrial vehicle, login credentials from an operator;
determining, if the industrial vehicle includes the lanyard, that the lanyard is secured after the lanyard was not secured; and
enabling the industrial vehicle after receiving the login credentials and determining that the lanyard is secured after the lanyard was not secured.

2. The process of claim 1, wherein determining whether the industrial vehicle includes a lanyard that is associated to the industrial vehicle comprises:
receiving a wireless status message from the lanyard, wherein the wireless status message includes identification data of the lanyard.

3. The process of claim 1, wherein determining, if the industrial vehicle includes the lanyard, that the lanyard is secured after the lanyard was not secured comprises detecting an edge on a signal from the lanyard, wherein the signal indicates a secured state of the lanyard.

4. The process of claim 1, wherein determining, if the industrial vehicle includes the lanyard, that the lanyard is secured after the lanyard was not secured comprises receiving a status message indicating that the lanyard is in an unsecured state and then receiving a status message indicating that the lanyard is in a secured state.

5. The process of claim 1, wherein determining that the lanyard is secured after the lanyard was not secured occurs after receiving the login credentials from the operator.

6. The process of claim 1, wherein determining that the lanyard is secured after the lanyard was not secured occurs within a predetermined time period before receiving the login credentials from the operator.

7. The process of claim 1, wherein determining that the lanyard is secured after the lanyard was not secured occurs:
after receiving the login credentials from the operator; or
within a predetermined time period before receiving the login credentials from the operator.

8. The process of claim 1 further comprising:
keeping the industrial vehicle enabled until the operator logs out or unsecures the lanyard.

9. A process for associating a lanyard with an industrial vehicle, wherein the lanyard communicates with the industrial vehicle wirelessly, the process comprising:
receiving, on an industrial vehicle, a request from a lanyard to wirelessly pair with the industrial vehicle, wherein the request includes identification information of the lanyard;
sending an instruction to an operator to perform a task, for a predetermined number of times, of unsecuring the lanyard and securing the lanyard;
receiving an indication that the lanyard is secured after the lanyard was not secured for the predetermined number of times, wherein the indication includes the identification information of the lanyard; and
associating the lanyard with the industrial vehicle for communication with the industrial vehicle after determining that the lanyard has been secured after the lanyard was not secured for the predetermined number of times.

10. The process of claim 9 further comprising:
sending the identification information of the lanyard to a screen for display to the operator.

11. The process of claim 10, wherein sending the identification information of the lanyard to a screen for display to the operator comprises filtering out any identification information that is not associated with a lanyard.

12. The process of claim 10, further comprising receiving, from the operator, an indication whether the identification information of the lanyard is correct;
wherein associating the lanyard with the industrial vehicle for communication with the industrial vehicle further comprises associating the lanyard with the industrial vehicle for communication with the industrial vehicle if the indication of whether the identification information of the lanyard is correct indicates that the identification information of the lanyard is correct.

13. The process of claim 10, wherein:
sending an instruction to an operator to perform a task, for a predetermined number of times, of unsecuring the lanyard and securing the lanyard comprises sending an instruction to a screen for the operator to perform the task.

14. The process of claim 10, wherein:
receiving an indication that the lanyard is secured after the lanyard was not secured for the predetermined number of times further comprises a receiving periodic status message from the lanyard that indicates whether the lanyard is secured or unsecured.

15. The process of claim 14, wherein sending an instruction to an operator to perform a task, for a predetermined number of times, of unsecuring the lanyard and securing the lanyard comprises:
counting a number of times the operator has performed the task; and
updating the instruction for the operator to perform the task for the predetermined number of times minus the number of times that the operator has performed the task.

16. A process for enabling an industrial vehicle, the process comprising:
receiving, on an industrial vehicle, a request from a lanyard to wirelessly pair with the industrial vehicle, wherein the request includes identification data of the lanyard;
sending an instruction to an operator to perform a task, for a predetermined number of times, of unsecuring the lanyard and securing the lanyard;
receiving an indication that the lanyard is secured after the lanyard was not secured for the predetermined number of times, wherein the indication includes the identification information of the lanyard;
associating the lanyard with the industrial vehicle for communication with the industrial vehicle after determining that the lanyard has been secured after the lanyard was not secured for the predetermined number of times;
receiving, on the industrial vehicle, login credentials from an operator;
determining that the lanyard is secured after the lanyard was not secured; and
enabling the industrial vehicle after receiving the login credentials and determining that the lanyard is secured after the lanyard was not secured.

17. The process of claim 16, wherein determining that the lanyard is secured after the lanyard was not secured occurs:
after receiving the login credentials from the operator; or
within a predetermined time period before receiving the login credentials from the operator.

18. The process of claim 16, wherein:
sending an instruction to an operator to perform a task, for a predetermined number of times, of unsecuring the lanyard and securing the lanyard comprises sending an instruction to a screen for the operator to perform the task.

19. The process of claim 16, wherein:
receiving an indication that the lanyard is secured after the lanyard was not secured for the predetermined number of times further comprises receiving a separate signal for each time the lanyard is secured after the lanyard was not secured.

20. The process of claim 19, wherein:
receiving an indication that the lanyard is secured after the lanyard was not secured for the predetermined number of times further comprises:
determining that the lanyard is secured after the lanyard was not secured for the predetermined number of times; and
waiting for a predetermined amount of time for another indication that the lanyard is secured after the lanyard was not secured; and
associating the lanyard with the industrial vehicle for communication with the industrial vehicle comprises:
associating the lanyard with the industrial vehicle for communication with the industrial vehicle after determining that the lanyard has been secured after the lanyard was not secured for the predetermined number of times and another indication that the lanyard is secured after the lanyard was not secured before the predetermined amount of time has lapsed.
